(19) United States
(12) Patent Application Publication
(10) Pub. No.: US 2007/0173235 A1
(43) Pub. Date: Jul. 26, 2007

(54) SYSTEM AND/OR METHOD FOR INTERACTIVE MERCHANDISING OF DIGITAL CONTENT

(75) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(73) Assignee: Edward Merritt, Lenox, MA (US)

(21) Appl. No.: 11/613,965

(22) Filed: Dec. 20, 2006

Related U.S. Application Data
(60) Provisional application No. 60/752,113, filed on Dec. 20, 2005.

(51) Int. Cl. H04Q 7/38; H04Q 7/22; H04M 3/42

(52) U.S. Cl. 455/414.1

(57) ABSTRACT

Embodiments of methods, devices and/or systems for interactive merchandising of digital content are described.

### RELATED APPLICATION

The current patent application claims priority to U.S. Provisional Patent Application Ser. No. 60/752,113, filed on Dec. 20, 2005.

### FIELD

This disclosure is related to digital content, such as digital content that may be embodied on digital media products, and merchandising thereof.

### BACKGROUND

Merchandising typically includes selling of retail products, performed in a retail environment. Currently, conventional models for selling of digital media products typically may include aisles in a retail setting having shelving and filing separators to display digital media products fully packaged for sale such as CDs and DVDs. The CDs and DVDs may store music, software, interactive games, movies and/or other digital content, for example. Additionally, conventional retail merchandising models may include end cap displays, which may form the ends of aisles and may be used to display products, in addition to stand alone islands or kiosks that display digital media products. These conventional displays may additionally offer previewing capabilities of the digital content, such as listening, viewing and/or playing stations. Typically, in these environments, when a customer finds an item in the conventional display for purchase, the customer may removes the item from the display and bring it to a cashier counter. Alternatively, the customer may request a clerk to retrieve the product from a secured area only accessible by the clerk. The customer may then bring the retrieved item to the cashier for purchase.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 illustrates one embodiment of a merchandising system which may be employed in one or more embodiments;

FIG. 2 illustrates one embodiment of a merchandising system which may be employed in one or more embodiments;

FIG. 3 illustrates one embodiment of a merchandising system which may be employed in one or more embodiments;

FIG. 4 illustrates one embodiment of a merchandising system and a method of using same, which may be employed in one or more embodiments;

FIG. 5 illustrates one embodiment of a merchandising system and a method of using same, which may be employed in one or more embodiments;

FIG. 6 illustrates one embodiment of a merchandising system and a method of using same, which may be employed in one or more embodiments;

FIG. 7 illustrates a flow diagram illustrating one embodiment of a process for merchandising digital content; and

FIG. 8 illustrates a flow diagram illustrating one embodiment of a process for merchandising digital content.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “providing”, “sending,”, “receiving”, “determining”, “detecting”, “scanning”, “forming”, “identifying”, “enabling”, “accessing”, “presenting” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing system refers to a system or a device that includes the ability to process and/or store data in the form of signals. Thus, a computing system, in this context, may comprise hardware, software, firmware and/or any combination thereof. Further, unless specifically stated otherwise, a process as described herein, with reference to flow diagrams or otherwise, may also be executed and/or controlled, in whole or in part, by a computing system.

“Merchandising” as referred to herein relates to the promotion, advertising, sales, production, marketing, display, presenting and/or development of products. In one particular example, merchandising of digital content may comprise the promotion, advertising, sales, production, marketing, presenting and/or development of the digital content and/or digital media products that may have the digital content stored thereon. Accordingly, a “Merchandising System” as referred to herein relates to a device having functionality to enable merchandising of products. Accordingly, a merchandising system may be adapted to advertise, present, sell, dispense, produce and/or otherwise merchandise products such as digital content and/or digital media products. Additionally, a merchandising system may alternatively be referred to as a “Merchandiser”, and these terms may be used interchangeably.

A “Digital Media Product”, as referred to herein relates to one or more storage mediums such as magnetic disk, magnetic tape, recordable media including DVD and CD, memory devices such as flash memory and/or semiconductor devices that may have stored thereon digital content in a format that is retrievable in response to requests and/or commands, and may, in some contexts, be referred to as digital media. “Digital Content” as referred to herein relates to digital information stored in a storage medium in some retrievable format. For example, digital content may comprise information in a particular format, such as in one or more media formats that comply with MP3, MP4, WMA, MPG, EXE, WAV and MIDI format. However, these are merely examples of media formats according to particular embodiments, and claimed subject matter is not limited in this respect. Additionally, examples of digital content may comprise music, software, interactive games and movies and/or other types and categories of digital content but again, the claimed subject matter is not limited in this respect.

“Presenting” as referred to herein relates to the execution of digital content, and the particular manner of presenting depends at least in part on the media format of the digital content. For example, presentation of digital content in MP3, WAV or MIDI format may comprise processing the digital content on an audio system such as a stereo system. Additionally, presentation of digital content in WMA or MPG format may comprise processing the digital content for display on a monitor and/or an audio system concurrently. However, these are merely examples, and the claimed subject matter is not limited in this respect. Accordingly, “previewing” digital content may comprise presenting less than the entire portion of digital content. For example, previewing digital content in MP3, WAV or MIDI format may comprise presenting a portion of the digital content on an audio system. However, again, these are merely examples, and the claimed subject matter is not limited in this respect.

The following discussion details several possible embodiments, although these are merely examples and are not intended to limit the scope of claimed subject matter. Embodiments may be implemented in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a recordable media that may have stored thereon instructions, that when executed by a system, such as a computer system, computing platform, or other system, for example, may result in an embodiment of a method in accordance with claimed subject matter being executed.

As alluded to previously, it may be desirable, for a variety of reasons, to sell digital content, and it may be further desirable to sell digital content interactively. For example, it may be desirable to at least partially integrate a customer into the sales, display and/or testing of digital content, manufacture of digital media including the digital content, and/or downloading of digital content, such as in a retail environment. The digital content may be embodied on a storage medium, a computing platform and/or on digital media products, for example.

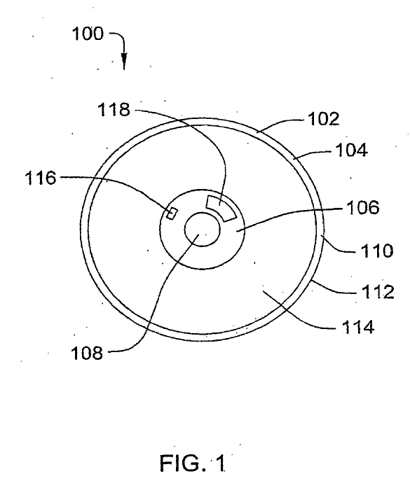

Referring now to FIG. 1, there is illustrated a merchandising system that may be employed in one or more embodiments. FIG. 1 comprises an aisle merchandising system 100, which may be employed in a retail environment, and may be configured in an aisle of the retail environment, for example. In this embodiment, a bin card separator 102, or alternatively or additionally a digital media product such as a CD or DVD may be labeled with a bar code 103. The bar code 103 may be scanned by use of a bar code scanner 104. Alternatively or additionally, the bin card separator 102, or a CD or DVD may be coupled to Radio-Frequency Identification (RFID) circuitry, which may be adapted to emit a signal detectable and/or readable by an RFID reader 106. The bin card separator 102, or a CD or DVD may be selected by a customer. In one embodiment, selection may comprise physically removing the bin card from the merchandising system or from a portion thereof. Removal may be detected by detecting an RFID signal of RFID circuitry disposed on the bin card separator 102, and may be detected by the RFID reader 106, for example. Alternatively, selection may comprise scanning bar code 103 by use of the bar code scanner 104. Bar code scanner 104 may be employed by a customer to scan bar code 103, for example. However, other methods for selection may be employed in alternative embodiments. In response to the selection, in one embodiment, digital content stored on the digital media product may be presented by activating a video screen display 108, and/or audio content of the digital media product may be presented by use of speakers 110 or headphones 112. The display 108 and/or speakers 110 and/or headphones 112 that are employed to present the digital content may be proximate to the scanner 104 and/or RFID reader 106, or alternatively may be located at one or more locations remote with respect to bar code scanner 104 and/or RFID reader 106. For example, the digital content may be presented on displays in the area of the merchandising system 100, for example. A customer may subsequently purchase the presented digital media product. The digital media product may be purchased by use of key pad 114, which may comprise an RFID-enabled keypad. The digital media product may be purchased by performing a credit card identification swipe on a credit card scanner 118, or by use of RFID signals if credit card scanner 118 comprises an RFID enabled credit card scanner. Additionally, RFID reader 106 and an RFID-enabled credit card (not shown) may be employed to complete a purchase. Furthermore, a cell phone or mobile device and a mobile device scanner 105, or mobile device enabled with RFID circuitry which can be read via the RFID reader 106 may be employed to complete a purchase. However, these are merely examples, and the claimed subject matter is not so limited.

Additionally, continuing with FIG. 1, a purchase transaction may involve a customer verification process, which may be employed to verify the identity of a customer, for example. However, in other embodiments a verification process may not be employed, and the claimed subject matter is not limited in this respect. However, in this embodiment, customer verification may be performed by use of a pin entered on the keypad 114 or a pin entered on a mobile device (not shown). The customer may alternatively be verified via a series of RFID frequencies relayed back and forth from the keypad 114 or a mobile device (not shown). Customer verification may additionally be performed by use of an optical scanner 120, which may be adapted to scanning an eye or a thumbprint of a customer. Alternatively, verification may be performed by use of a retinal image or thumbprint of a customer, which may be provided by use of a retinal image or thumbprint scanner (not shown), or may be provided by use of a mobile device enabled to obtain a retinal or thumbprint image of the customer. In one embodiment, a multi-light display 122 indicates the status of the purchasing transaction. A printer 124, which may comprise a thermal printer, may create a receipt for goods purchased, and may be utilized to provide verification to store personnel of the item purchased, or may provide verification for customer service that may be employed to fulfill the customers purchase.

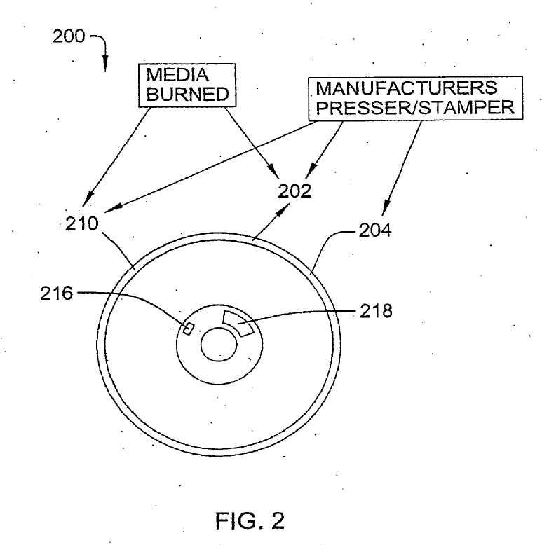

Referring now to FIG. 2, there is illustrated a merchandising system that may be employed in one or more embodiments. FIG. 2 comprises an end cap merchandising system 200, which may be employed in a retail environment and configured at the end of an aisle of the retail environment, for example. In this embodiment, although not illustrated in detail, end cap merchandising system 200 may include one or more of the features of aisle merchandising system 100 of FIG. 1, such as similar scanning, detecting, presenting, purchasing and/or verification functionality. However, such scanning, detecting, presenting, purchasing and/or verification functionality may be implemented differently from that described in connection with aisle merchandiser 100 of FIG. 1 without deviating from claimed subject matter.

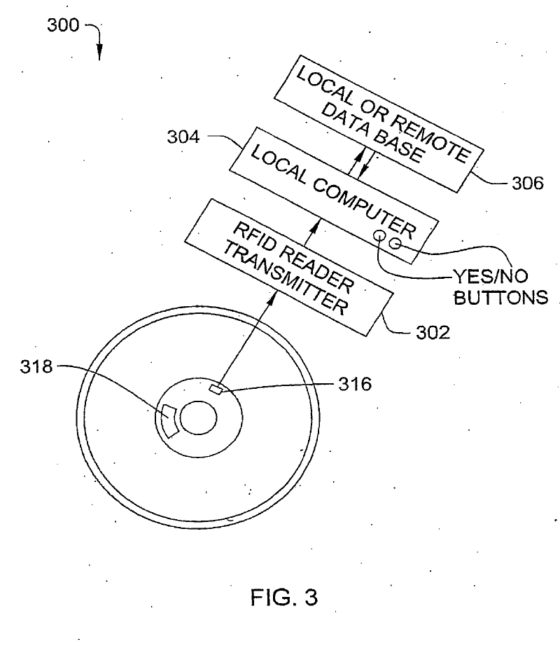

Referring now to FIG. 3, there is illustrated a merchandising system that may be employed in one or more embodiments. FIG. 3 comprises an island display merchandising system 300, which may be employed in a retail environment and configured in an area of the retail environment to form a stand-alone merchandising system, for example. In this embodiment, although not illustrated in detail, end cap merchandising system 300 may include one or more of the features of aisle merchandising system 100 of FIG. 1, such as similar scanning, detecting, presenting, purchasing and/or verification functionality, for example. Additionally, island merchandising system 300 may, in at least one embodiment, be employed as a stand alone display, not affixed to an end cap or aisle merchandising system. Additionally, island merchandising system 300 may be employed in the middle of an existing store aisle or near the entrance to a retail store or as a stand alone kiosk in a shopping mall, supermarket or other high traffic retail area, for example.

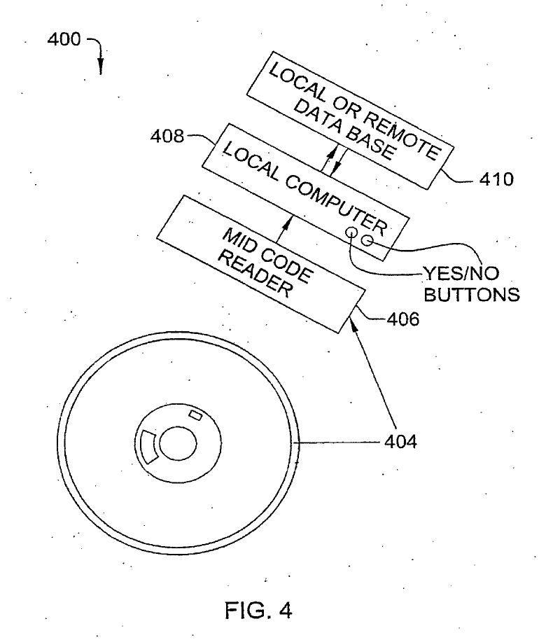

FIG. 4 illustrates a method of using a merchandising system, such as merchandising system 100 of FIG. 1, for example. Illustrated in FIG. 4 is a merchandising system 400, which comprises an aisle merchandising system employed in a retail environment and configured in an aisle of the retail environment, for example. A bin card separator 402, or alternatively a digital media product such as a CD or DVD may be labeled with a bar code 403. The bar code 403 may be scanned by use of a bar code scanner 404. Alternatively or additionally, the bin card separator 402, or a CD or DVD may be or embedded with RFID circuitry, which may emit a signal that is adapted to being read by an RFID reader 406. The bin card separator 402, or a CD or DVD may be selected. As mentioned previously, selection may be performed by a customer, and may comprise physically removing the bin card separator 402 from the merchandising system 400 such that RFID reader 406 may detect the removal by detecting an RFID signal, and/or may comprise scanning bar code 403 by use of the scanner. Again, however, claimed subject matter is not limited in this respect.

In operation, in response to selection of bin card separator 402 by a customer, data representative of the scanned bar code or the detected RFID signal may be automatically obtained. The data may be provided to a computing system 420. The computing system 420 may be communicatively coupled to a database 422, which may be local to the computing system or at a remote location, for example. A correlation may be made between data representative of the scanned bar code and/or the RFID signal, and this correlation may include identification of digital content. Identified digital content may be retrieved from content server 424 and provided to one or more portions of merchandising system 400 for presenting and/or previewing. For example, the content may be previewed on a video screen display 408, and/or through use of speakers or headphones (not shown). Such display 408 and/or speakers and/or headphones that are activated may be proximate to the bar code scanner 404 and/or RFID reader 406 that detected the selection. Alternatively, several portions of digital content may be presented on display 408, and a customer may scroll through the several portions of digital content and select one of the portions by employing keypad 414. The keypad may be utilized to scroll, search and/or select content for presentation, for example. In at least one embodiment, a mobile device 428 may be utilized to scroll, search and/or select content from the content server. Additionally, presenting content may comprise presenting content similar to the selected content. For example, if the content comprises a digital audio file such as a song, songs by the same artist and/or songs of the same genre may be presented. Additionally, if the content comprises a digital video file such as a movie, movies having the same actors and/or movies of the same genre may be presented. However, these are just examples and the claimed subject matter is not limited in this respect. Additionally, customer preferences may be employed to present content, and the content may comprise recommendations of additional digital content that a customer may be interested in purchasing based on customer preferences such as past purchases. For example, customer preferences may be determined based on past purchases and/or past selections of a customer, by additional customer input, and/or by use of a pre-formed customer profile, for example. Customer identification may be obtained by a credit card identification swipe on a credit card swipe scanner 418, or an RFID enabled credit card may be utilized to perform credit card identification on an RFID enabled scanner 416. Additionally, an optical scan of a customer fingerprint or retina may be performed by an optic scanner 430. The optical scan may be adapted to identifying the customer profile that may exist in a database and may access customer information as obtained via one or more of the above-described methods. A printer 432, which may comprise a thermal printer, may create a receipt for goods purchased, and may be utilized to provide verification to store personnel of the item purchased, or may provide verification for customer service that may be employed to fulfill the customers purchase.

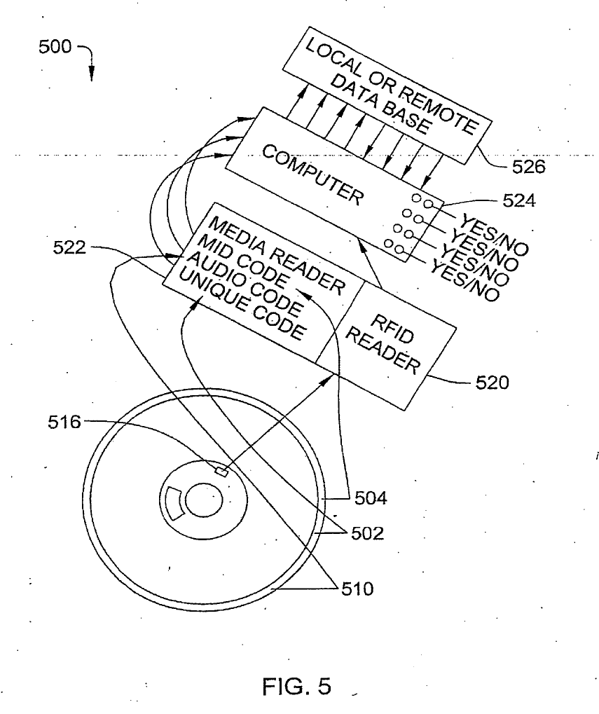

FIG. 5 illustrates a method of using a merchandising system 500, which comprises an aisle merchandiser employed in a retail environment and adapted for use with an aisle of the retail environment, for example. However, it is worthwhile to note that other types and configurations of merchandising systems may be employed in alternative embodiments. In this embodiment, a bin card separator 502, or alternatively a digital media product such as a CD or DVD 503, may be labeled with a bar code (not shown). The bar code may be scanned by use of a bar code scanner 504. Alternatively or additionally, the bin card separator 502, or a CD or DVD 503 may be or embedded with RFID circuitry, which may emit a signal that is adapted to being read by an RFID reader 506. The bin card separator 502, or a CD or DVD 503 may be selected, and selection may include scanning the bar code by use of the scanner, or detecting the RFID signal by the RFID reader 506, as described previously, for example.

In operation, when digital content is selected, data representative of the scanned bar code or the detected RFID signal may be obtained. The data may be provided to a computing system 520. The computing system 520 may be communicatively coupled to a database 522, which may be local to the computing system or at a remote location, for example. A correlation may be made between data representative of the scanned bar code and/or the RFID signal, and this correlation may include identification of digital content. A signal may be provided to a content server 524, and the content may be provided from the server to one or more portions of the merchandiser 500. For example, the content may be presented on a video screen display 508, and/or presented by use of speakers or headphones, such as described previously with reference to FIG. 4. Additionally, customer preferences may be utilized to select content for presenting. Customer identification may be utilized to determine customer preferences and present digital content based at least in part on the customer preferences, such as described previously with reference to FIG. 4.

Additionally illustrated in FIG. 5 is a method of employing the merchandising system 500 to enable a secure purchasing and/or receipt system. For example, a purchase selection of a digital media produce may be made. The purchase information and currency tendered may be by use of a credit card 530. The credit card 530 may be employed to perform a credit card swipe in a card swipe reader 518. Additionally, the credit card may be RFID enabled, and may be employed to perform a credit card swipe by use of an RFID reader 506. Alternatively, a retinal or thumbprint scan by use of an optic retinal scanner reader (not shown) may be utilized to at least partially perform a purchase transaction. Further, a keypad 512 that may be disposed on the merchandising system 500 and/or a wireless mobile device 528 may be utilized to at least partially perform a purchase transaction. Data obtained in one or more of the above-described manners may be provided to an external verification source 514, such as a credit or banking database. Alternatively, data may be provided to a computing system 520, which may have a secure connection to a verification source 514, and may provide the obtained data. The verification source may perform confirmation and verification of the customer data, and a message containing a confirmation number or rejection of the transaction may be provided to the computing system 520 and/or the merchandising system 500, such that a confirmation or rejection of the transaction may be provided to the customer. The confirmation may comprise a paper receipt provided by a thermal printer 516, and/or may comprise a display of the verified transaction on a video screen 508 or via audio speaker 532, for example.

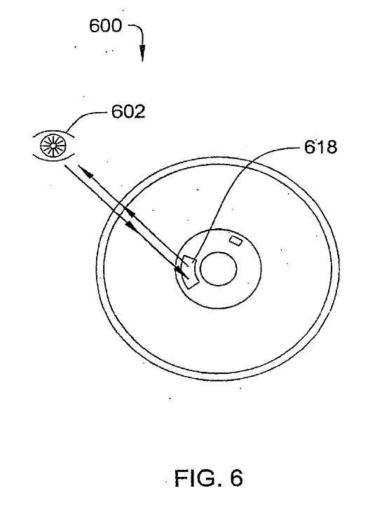

FIG. 6 illustrates a method of using a merchandising system to provide digital content. Illustrated in FIG. 6 is a merchandising system 600 which, in this embodiment, comprises an aisle merchandiser employed in a retail environment and configured in an aisle of the retail environment. Digital media products 610 may be removed from the merchandising system 600, and may be purchased in a manner such as described previously. Alternatively, digital content may be selected for purchase, and at some time subsequent to selection and/or purchase, the digital content may be provided to a media burner (not shown) coupled to merchandising system 600, to initiate the formation of a digital media product 602 embodying the selected digital content. When the burn is complete, the digital media product 602 may be provided through a burned media slot 604. Alternatively, after selection and/or purchase, the digital content may be made available for download. For example, the digital content may be provided by a content server, and may be made accessible by use of an output port 606, which may comprise a Universal Serial Bus (USB) or other portable media port. The digital content may be provided to a media player 612 or storage device of the purchaser, for example. Alternatively, one or more of the above-described processes may be performed in another area of the retail space, such as behind a retail counter, for example.

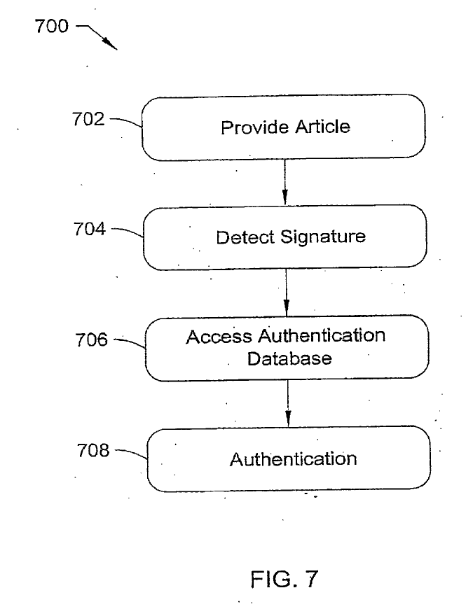

FIG. 7 is a flow diagram of an embodiment 700 of a process for merchandising digital content. However, claimed subject matter is not limited in scope to this particular example. For example, for flow diagrams presented herein, the order in which blocks are presented does not necessarily limit claimed subject matter to any particular order. Additionally, intervening blocks not shown may be employed without departing from the scope of claimed subject matter. Likewise, flow diagrams depicted herein may, in alternative embodiments, be implemented as a combination of hardware, software and/or firmware, such as part of a computer or computing system.

Continuing with FIG. 7, at block 702, digital content is selected. Selection may be performed by a customer, and may comprise physical removing a digital media product and/or a bin card separator from a merchandising system, such as illustrated in one or more of the previously-described embodiments. Alternatively, selection may comprise scanning a bar code or reading an RFID signal from RFID circuitry associated with the digital content, for example. However, as noted previously, the claimed subject matter is not limited in this respect. At block 704, the selected digital content is identified. Identification may comprise scanning a bar code on the digital media product and/or a bin card separator, and/or detection of an RFID signal, such as described previously. At block 706, selection data is provided to a database. Providing may be performed by use of a computing system, and the database may be local or remote. At block 708, a determination is made regarding whether a match is made between the selection data and digital content that may reside on a content server. If no match is made, at block 710, the customer may be prompted to select other digital content, and one or more of the previously-described blocks may be repeated. If a match is made, a content server may be accessed. The content server may include at least a portion of the selected digital content. At block 712, the selected digital content is presented, such as visually or audibly, by use of multi-media components that may be coupled to a merchandising system, for example.

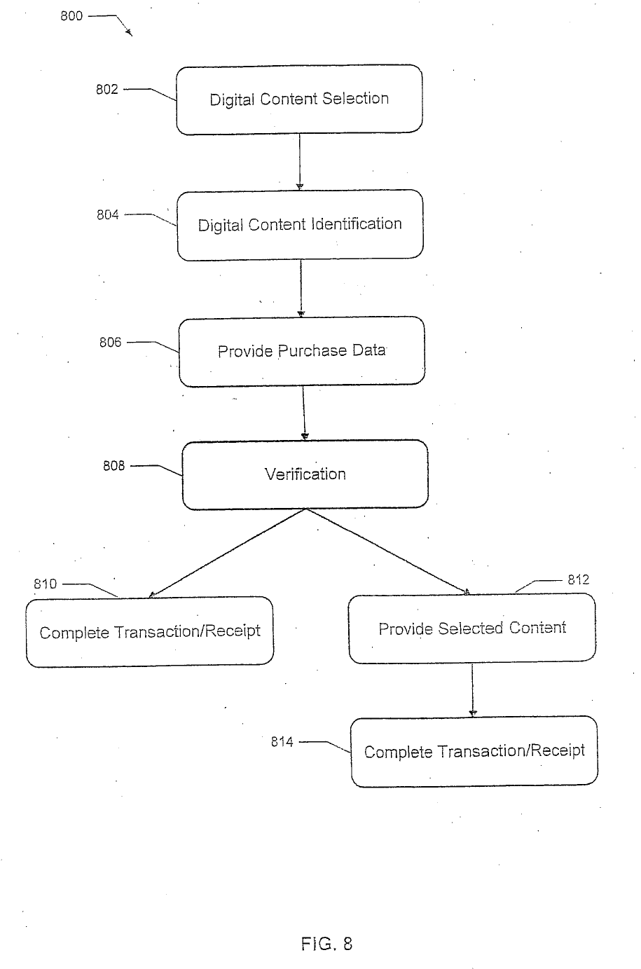

FIG. 8 is a flow diagram of an embodiment 800 of a process for merchandising digital content. At block 802, digital content is selected. Selection may be performed by a customer, and may comprise physical removing a digital media product and/or a bin card separator from a merchandising system, such as illustrated in one or more of the previously-described embodiments. Alternatively, selection may comprise scanning a bar code or reading an RFID signal from RFID circuitry associated with the digital content, for example. However, as noted previously, the claimed subject matter is not limited in this respect. At block 804, the selected digital content is identified. Identification may comprise scanning a bar code on the digital media product and/or a bin card separator, and/or detection of an RFID signal, such as described previously. At block 806, purchase data is provided, such as by the customer. Purchase data may comprise identification of the customer, a credit card number, account number and/or one or more other types of identification that may allow a purchase to be processed, for example. The identification may be provided by use of a credit card. The credit card may be employed to perform a credit card swipe in a card swipe reader. Additionally, the credit card may be RFID enabled, and may be employed to perform a credit card swipe by use of an RFID reader. Alternatively, a retinal or thumbprint scan by use of an optic retinal scanner reader may be utilized to at least partially perform a purchase transaction. Further, a keypad and/or a wireless mobile device may be utilized to at least partially provide purchase data. At block 808, purchase data obtained in one or more of the above-described manners is provided to an external verification source. The verification source may perform confirmation and verification of the customer data.

Continuing with flowchart 800, in one embodiment, a customer may purchase a digital media product, such as a packaged CD or DVD. In this embodiment, at block 810, a message containing a confirmation number or rejection of the transaction is provided to the merchandising system, such that a confirmation or rejection of the transaction may be provided to the customer. The confirmation may comprise a paper receipt provided by a thermal printer, and/or may comprise a display of the verified transaction on a video screen or via audio speaker, for example. Alternatively, at block 812, digital content is selected for purchase, and the digital content may be provided to a media burner coupled to a merchandising system, to initiate the formation of a digital media product including the selected digital media. When the burn is complete, the digital media product may be provided through a burned media slot. Alternatively, after selection and/or purchase, the digital content may be made available for download. For example, the digital content may be provided by a content server, and may be made accessible by use of an output port, such as a USB or other portable media port of the merchandising system. The digital content may be provided to a media player or storage device of the purchaser, for example. At block 814, a message containing a confirmation number or rejection of the transaction is provided to the merchandising system, such that a confirmation or rejection of the transaction may be provided to the customer. The confirmation may comprise a paper receipt provided by a thermal printer, and/or may comprise a display of the verified transaction on a video screen or via audio speaker, for example.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method, comprising:
identifying a selection of digital content in response to detection of motion of a digital media product having the digital content stored thereon; and
automatically presenting a portion of the digital content on a display portion of a merchandising system in response to the identifying.

2. The method of claim 1, further comprising:
enabling purchase of the digital media product from the merchandising system.

3. The method of claim 1, further comprising:
enabling download of the digital content from the merchandising system.

4. The method of claim 2, wherein enabling purchase further comprises:
forming a digital media product embodying the digital content.

5. The method of claim 1, further comprising:
identifying a profile of a customer that selected the digital content; and
displaying additional digital content on a display portion of the merchandising system in response to the identified profile.

6. The method of claim 1, wherein identifying a selection comprises:
detecting an RFID signal associated with the selected digital media product.

7. The method of claim 1, wherein identifying a selection comprises:
scanning a bar code associated with the selected digital media product.

8. The method of claim 1, wherein automatically presenting further comprises:
accessing a content server;
obtaining a portion of the digital content embodied on the digital media product from the content server; and
presenting the obtained digital content on a display portion of the merchandising system.

9. The method of claim 1, wherein the display portion comprises at least one of: speakers, headphones, monitor and television.

10. A merchandising system, comprising:
a plurality of bin cards, at least a portion of the bin cards being respectively associated with a set of digital content;
an identifier, to identify a selection of a set of digital content in response to detection of motion of a bin card associated with the set of digital content; and
a display, to present a portion of the selected set of digital content in response to the detected motion.

11. The merchandising system of claim 10, wherein the display comprises at least one of: speakers, headphones, monitor and television.

12. The merchandising system of claim 10, further comprising:
a credit card reader; and
a credit card verification database.

13. The merchandising system of claim 10, wherein the identifier comprises an RFID reader.

14. The merchandising system of claim 10, wherein the identifier comprises a bar code scanner.

15. The merchandising system of claim 12, wherein the credit card reader comprises an RFID reader.

16. The merchandising system of claim 12, wherein the credit card reader comprises a credit card swipe reader.

17. The merchandising system of claim 10, further comprising a media port adapted to enable downloading of digital content.

18. The merchandising system of claim 10, further comprising a media burner adapted to burn digital content on a recordable media product in response to the selection.

19. A merchandising system, comprising:
a plurality of digital media products having digital content stored thereon;
an identifier, to identify a selection of digital content in response to detection of motion of one of said digital media products having digital content stored thereon; and
a display, to present a portion of the selected digital content in response to the detected motion.

20. The merchandising system of claim 19, wherein the display comprises at least one of: speakers, headphones, monitor and television.

21. The merchandising system of claim 19, further comprising:
a credit card reader; and
a credit card verification database.

22. The merchandising system of claim 19, wherein the identifier comprises an RFID reader.

23. The merchandising system of claim 19, wherein the identifier comprises a bar code scanner.

24. The merchandising system of claim 21, wherein the credit card reader comprises an RFID reader.

25. The merchandising system of claim 21, wherein the credit card reader comprises a credit card swipe reader.

26. The merchandising system of claim 19, further comprising a media port adapted to enable downloading of digital content.

27. The merchandising system of claim 19, further comprising a media burner adapted to burn digital content on a recordable media product in response to the selection.
